(19) United States
(12) Patent Application Publication
(10) Pub. No.: US 2022/0272917 A1
(43) Pub. Date: Sep. 1, 2022

(54) AN AEROPONIC FARMING SYSTEM AND A METHOD

(71) Applicant: AEROPOD OY, Ylistaro (FI)

(72) Inventors: Raine HERMANS, Ylistaro (FI); Markku PEITTOLA, Ylistaro (FI)

(21) Appl. No.: 17/632,517

(22) PCT Filed: Aug. 5, 2020
(86) PCT No.: PCT/FI2020/050519

§ 371 Date: Feb. 3, 2022

(30) Foreign Application Priority Data
Aug. 6, 2019 (FI) 20195667

(51) Int. Cl. A01G 31/02

(52) U.S. Cl. CPC A01G 31/02

(57) ABSTRACT

An aeroponic farming system and a method in connection with aeroponic farming for growing tuber plants or root vegetable plants having an aerial shoot and underground root part. The system includes a growing chamber having growing chamber walls defining a closed chamber space and one or more growing liquid nozzles arranged to spray growing liquid inside the closed chamber space of the growing chamber. The aeroponic farming system further includes a thermal adjustment device arranged to adjust temperature of the growing liquid in the aeroponic farming system for adjusting the temperature in the inside the closed chamber space of the growing chamber.

### FIELD OF THE INVENTION

The present invention relates to an aeroponic farming system and more particularly to an aeroponic farming system according to the preamble of claim 1. The present invention further relates to a method for aeroponic farming and more particularly to a method according to preamble of claim 14.

### BACKGROUND OF THE INVENTION

Aeroponic farming is the process of growing plants in an air or mist environment without the use of soil or an aggregate medium, known as geoponics. Aeroponic farming differs from conventional hydroponic farming, known as aquaponics. Unlike hydroponics, which uses a liquid nutrient solution as a growing medium and essential minerals to sustain plant growth, aeroponics is conducted without a growing medium. Accordingly, in aeroponic farming the roots or root part of the plant is not placed or immersed in any solid or liquid growing medium.

The basic principle of aeroponic growing is to grow plants suspended in a closed or semi-closed environment by spraying the dangling roots or the plant with an atomized or sprayed, nutrient rich water solution, meaning growing liquid. The leaves and crown, often called the aerial shoot, extend above and outside the closed environment. The roots of the plant are separated by the plant support structure to which the plant is supported such that the roots extend from the plant support structure to the closed environment. Often, foam or other elastic material is compressed around the lower stem or the plant and inserted into an opening in the plans support structure. The closed environment is arranged to be dark by providing a growing chamber having non-transparent chamber walls.

During the aeroponic growing process the roots of the plant are sprayed with the growing liquid at certain intervals in the growing chamber which provides the closed and dark environment. Excessive growing liquid flows or drops to bottom of the growing chamber from the bottom of the growing chamber the excessive growing liquid may be drained by utilizing gravity.

One of the problems associated with the prior art is temperature control inside the growing chamber. The root part of the plant needs to be kept at a certain temperature which is specific for the plant in order that the plant survives the aeroponic farming and growing environment may be provided to be substantially natural for the temperature. Further, the tuber plants or root vegetables are farmed in aeroponic farming system, the temperature needs to be controlled in detail and taking into account different temperature requirements in different growth stages of the plant such that production of tuber or root vegetables may be achieved. Temperature conditions outside the growing chamber and the aeroponic farming system may vary considerably over time or during a day due to weather conditions and between day and night. These surrounding temperature conditions have an effect to the temperature conditions inside the growing chamber. Therefore, the temperature inside the growing chamber needs to be controlled and maintained substantially constant.

### BRIEF DESCRIPTION OF THE INVENTION

An object of the present invention is to provide an aeroponic farming system and method for aeroponic farming so as to overcome or at least alleviate the prior art disadvantages.

The objects of the invention are achieved by an aeroponic farming system which is characterized by what is stated in the independent claim 1. The objects of the invention are further achieved by a method for aeroponic farming which is characterized by what is stated in the independent claim 14.

The preferred embodiments of the invention are disclosed in the dependent claims.

The invention is based on the idea of providing an aeroponic farming system for growing plants having an aerial shoot and underground root part. The plants may be tuber plants or root vegetable having tubers or root vegetables in the root part of the plant.

The system comprises a plant support base for supporting the plant. The plant support base comprises a support opening arranged to support the plant such that the plant extends through the plant support base via the support opening and such that the aerial shoot is arranged on a first side of the plant support base and the root part is arranged on a second side the plant support base. The aeroponic farming system further comprises a growing chamber provided on the second side of the plant support base. The growing chamber comprises growing chamber walls defining a closed chamber space. The growing chamber walls being non-transparent such that light is prevented from entering the growing chamber from outside and the closed growing chamber may be kept dark.

The aeroponic farming system is further provided one or more growing liquid nozzles arranged to spray growing liquid inside the closed chamber space of the growing chamber. The growing liquid nozzles may be arranged to the growing chamber walls or inside the growing chamber and arranged to spray growing liquid to the root part of the plant in closed chamber space.

In one embodiment, the growing liquid nozzles are arranged inside the closed chamber space of the growing chamber.

In another embodiment, nozzle head through which the growing liquid discharges from the growing liquid nozzles is open into the closed chamber space of the growing chamber for spraying growing liquid into the closed chamber space. Accordingly, the growing liquid nozzle is arranged to or in connection with the growing chamber such that the nozzle head of the growing liquid nozzle is open into the closed chamber space. Thus, the growing liquid nozzle may be arranged inside the growing chamber or to the chamber wall or inside the or through the chamber wall of the growing chamber. The growing liquid nozzle may also be arranged outside the growing chamber or embedded into the chamber walls or to the partitioning wall such that the nozzle head is open to the closed chamber space.

According to the present invention, the aeroponic farming system comprises a thermal adjustment device arranged to adjust temperature of the growing liquid in the aeroponic farming system for adjusting the temperature in the inside the closed chamber space of the growing chamber. Therefore, in the present invention the temperature inside the closed chamber space is controlled or adjusted by controlling or adjusting the temperature of the growing liquid.

Liquid material has high heat transfer coefficient and therefore controlling the temperature of the growing liquid provides efficient control and adjustment of the temperature in the closed chamber space inside the growing chamber. Furthermore, liquid material further has a high specific heat capacity which enables maintaining constant temperature in the closed chamber space inside the growing chamber. Thus, the temperature variations in the closed chamber space inside the growing chamber may be minimized due to surrounding temperature variations.

The growing liquid is a water based liquid comprising nutrients, such as nitrogen. Water has a heat transfer coefficient and also high specific heat capacity.

The thermal adjustment device is heating device, cooling device or a combined heating and cooling device. The thermal adjustment device may be for example electrical heating device, electrical cooling device, combined electrical heating and cooling device, or heat exchanger arranged to adjust temperature of the growing liquid in the system, or some other liquid heating and/or cooling device.

In ne embodiment, the thermal adjustment device is arranged to adjust temperature of the growing liquid sprayed from the growing liquid nozzles.

Accordingly, the thermal adjustment device is provided to or in connection with the one or more growing liquid nozzles. Thus, the thermal adjustment device is arranged to adjust the temperate of the growing liquid in the one or more growing liquid nozzles. Thus, the thermal adjustment device is arranged to adjust the temperate of the growing liquid during or upon spraying the growing liquid into the closed chamber space.

In another embodiment, the system comprises a growing liquid supply channel connected to the one or more growing liquid nozzles, and the thermal adjustment device is provided in connection with or to the growing liquid supply channel and arranged to adjust temperature of the growing liquid sprayed from the growing liquid nozzle. Thus, the temperature of the growing liquid is adjusted upstream of the growing liquid nozzles and prior to spraying the growing liquid into the closed chamber space. The thermal adjustment device is arranged to the growing liquid supply channel upstream of the growing liquid nozzles. This, provides a simple structure for the thermal adjustment device. The growing liquid may be heated or cooled with an electric heating and/or cooling device or the growing liquid may flow through a heat exchanger upstream of the growing liquid nozzles.

In another embodiment, the system comprises a growing liquid supply pump arranged to supply growing liquid to the one or more growing liquid nozzles and the thermal adjustment device is provided in connection with or to the growing liquid supply pump and arranged to adjust temperature of the growing liquid sprayed from the growing liquid nozzles. Thus, the temperature of the growing liquid is adjusted upstream of the growing liquid nozzles and prior to spraying the growing liquid into the closed chamber space. The thermal adjustment device is arranged to the growing liquid supply pump upstream of the growing liquid nozzles. This, provides a simple structure in which the number of separate equipment is minimized. The growing liquid may be heated or cooled with an electric heating and/or cooling device or the growing liquid may flow through a heat exchanger in connection with the growing liquid supply pump.

The growing liquid pump is arranged to supply growing liquid to the growing liquid nozzles via the growing liquid supply channel.

In a further embodiment, the system comprises a growing liquid source connected to the one or more growing liquid nozzles, and the thermal adjustment device is provided in connection with or to the growing liquid source and arranged to adjust temperature of the growing liquid sprayed from the growing liquid nozzles. Thus, the temperature of the growing liquid is adjusted upstream of the growing liquid nozzles and prior to spraying the growing liquid into the closed chamber space. The thermal adjustment device is arranged to the growing liquid source upstream of the growing liquid nozzles. This, enables keeping the growing liquid is desired temperature in the growing liquid source and avoids adjusting the temperature of the growing liquid only upon supplying to or spraying with growing liquid nozzles. Therefore, good energy efficient can be achieved. The growing liquid may be heated or cooled with an electric heating and/or cooling device or the growing liquid may flow through a heat exchanger provided in connection with or to the growing liquid source.

The growing liquid pump is arranged to supply growing liquid from the growing liquid source to the growing liquid nozzles via the growing liquid supply channel.

In one embodiment, the growing chamber comprises a growing liquid reservoir inside the growing chamber for storing growing liquid inside the closed chamber space of the growing chamber.

In one embodiment, the growing liquid reservoir is a separate reservoir or container arranged inside the closed chamber of the growing chamber.

In another embodiment, the growing liquid reservoir is formed by the chamber walls of the growing chamber. Thus, the chamber walls are provided waterproof such that the growing liquid reservoir is formed inside the growing chamber.

In one embodiment, the growing chamber comprises a partitioning wall arranged to divide the closed chamber space into an upper growing space and a lower liquid space. The upper growing space is provided between the plant support base and the partitioning wall for enclosing the root part of the plant. The lower liquid space is provided between the partitioning sheet and a bottom wall of the growing chamber. The lower liquid space comprises the growing liquid reservoir inside the growing chamber for storing growing liquid inside the closed chamber space of the growing chamber. The root part of the plant is arranged into the upper growing space and the partitioning walls keeps the root part away from the liquid collected or stored in the growing liquid reservoir.

In one embodiment, the aeroponic growing system further comprises a discharge connection provided between the upper growing space and the lower liquid space. The discharge connection being arranged to discharge excessive growing liquid sprayed into the upper growing space from the upper growing space to the lower liquid space or to the growing liquid reservoir in the lower liquid space. Accordingly, the excessive growing liquid is discharged from the upper growing space in which the root part of the plant is arranged. Thus, the growing liquid does not accumulate to the upper growing space but may be transported to the lower liquid space from which it may be circulated to the growing liquid nozzles. Further, the root part of the plant is not retained in the growing liquid and prevented from deteriorating.

Preferably, the discharge connection is provided inside the growing chamber. However, the discharge connection may also be provided between the upper growing space and the lower liquid space outside the growing chamber.

In another embodiment, the aeroponic growing system further comprises a discharge connection provided to the partitioning wall between the upper growing space and the lower liquid space. The discharge connection being arranged to discharge excessive growing liquid sprayed into the upper growing space from the upper growing space to the lower liquid space or to the growing liquid reservoir in the lower liquid space. In this embodiment, the growing liquid is discharged from the upper growing space via or through the partitioning wall between the upper growing space and the lower liquid space. Thus, the excessive growing liquid may drop from the root part of the plant on the partitioning wall and flow via or through the partitioning wall to the lower liquid space. Therefore, no separate discharge connection needs to be provided outside the growing chamber.

In one embodiment, the partitioning wall is made of liquid permeable fabric material, net material, or grid material allowing excessive growing liquid flow through the partitioning wall from the upper growing space to the lower liquid space. In this embodiment, the partitioning wall comprises holes or grid or net holes or is made of porous material allowing or some other liquid permeable material allowing growing liquid flow through the partitioning wall material from the upper growing space to the lower liquid space. Thus, no separate discharge connection is needed. Accumulation of excessive growing liquid in the upper growing space is prevented.

In another embodiment, the partitioning wall is made of liquid impermeable plate material or liquid impermeable fabric material and provided with one or more flow openings allowing excessive growing liquid flow through the partitioning wall from the upper growing space to the lower liquid space. In this embodiment, the excessive growing liquid is guided through the flow opening(s) in the partitioning wall form the upper growing space to the lower liquid space for discharging the excessive growing liquid from the upper growing space. This provides a controlled discharge of the growing liquid.

In a further embodiment, the partitioning wall is made of liquid impermeable plate or liquid impermeable fabric material, and the system comprises a flow connection provided or extending between the upper growing space and the lower liquid space allowing excessive growing liquid flow from the upper growing space to the lower liquid space. Preferably, the discharge connection is provided inside the growing chamber. However, the discharge connection may also be provided between the upper growing space and the lower liquid space outside the growing chamber. This allows also controlled discharge of the excessive growing liquid.

In one embodiment of the present invention, the thermal adjustment device is arranged to adjust the temperature of the growing liquid in the growing liquid reservoir.

Adjusting the temperature of the growing liquid stored or collected into the growing liquid reservoir inside the growing chamber further adjusts temperature inside the closed chamber space of the growing chamber. Accordingly, the temperature in the upper growing space or part of the closed chamber space is adjusted by adjusting the temperature of the growing liquid in the growing liquid reservoir.

In one embodiment, be thermal adjustment device is arranged in connection with or to the growing liquid reservoir and arranged to adjust the temperature of the growing liquid in the growing liquid reservoir. In some embodiments, the thermal adjustment device is arranged inside the growing liquid reservoir.

In one embodiment, the system comprises a growing liquid circulation arrangement arranged to supply growing liquid from the growing liquid reservoir to one or more of the growing liquid nozzles.

Accordingly, growing liquid is supplied from the growing liquid reservoir to the growing liquid nozzles with the growing liquid circulation arrangement. Excessive growing liquid sprayed from the growing liquid nozzles is collected back to the growing liquid reservoir and circulated again to the growing liquid nozzles.

In one embodiment, the growing liquid circulation arrangement comprises a circulation channel connected to the one or more growing liquid nozzles. The thermal adjustment device is provided in connection with or to the circulation channel and arranged to adjust temperature of the growing liquid sprayed from the growing liquid nozzles. Accordingly, the temperature inside the growing chamber may be adjusted by spraying the growing liquid and adjusting the excessive temperature of the growing liquid flowing back to the growing liquid reservoir.

In another embodiment, the growing liquid circulation arrangement comprises circulation pump arranged to supply growing liquid to the one or more growing liquid nozzles from the growing liquid reservoir. The thermal adjustment device is provided in connection with or to the circulation pump and arranged to adjust temperature of the growing liquid sprayed from the growing liquid nozzles.

Accordingly, the temperature inside the growing chamber may be upon pumping or supplying growing liquid to the growing liquid nozzles via the growing liquid circulation arrangement.

The circulation pump is in some embodiments arranged inside the growing liquid reservoir. In alternative embodiments, the circulation pump is in some embodiments arranged outside the growing liquid reservoir and a circulation inlet channel is arranged to extend from the growing liquid reservoir to the circulation pump.

The growing liquid circulation arrangement comprises the circulation pump and the circulation channel arranged to extend between the circulation pump and the growing liquid nozzles.

When the thermal adjustment device is provided in connection with or to the growing liquid reservoir the circulated and sprayed growing liquid may be already in desired temperature and the thermal adjustment device in the growing liquid circulation arrangement may be omitted, but may also be included in some embodiments.

The thermal adjustment device is a heating device or a cooling device or a combined heating and cooling device.

In some embodiments, the system comprises a first thermal adjustment device and a second thermal adjustment device.

In one embodiment, the first thermal adjustment device is arranged in connection with or to the growing liquid supply channel, supply pump or the growing liquid source. Thus, the first thermal adjustment device is arranged in the growing liquid inlet arrangement of the system. The second thermal adjustment device is arranged in connection with or to the growing liquid reservoir.

In another embodiment, the first thermal adjustment device is arranged in connection with or to the growing liquid supply channel, supply pump or the growing liquid source. Thus, the first thermal adjustment device is arranged in the growing liquid inlet arrangement of the system. The second thermal adjustment device is arranged in connection with or to the circulation arrangement.

In a further embodiment, the first thermal adjustment device is arranged in connection with or to the growing liquid reservoir and the second thermal adjustment device is arranged in connection with or to the circulation arrangement.

The growing liquid inlet arrangement or the growing liquid supply channel may be connected to the one or more growing liquid nozzles or to the growing liquid reservoir.

Relating to the above mentioned embodiments with the first and second thermal adjustment device, several different embodiments may be provided. In one embodiment, the first thermal adjustment device is a heating device and the second thermal adjustment device is a cooling device. In another embodiment, the first thermal adjustment device is a cooling device and the second thermal adjustment device is a heating device. In a further embodiment, the first thermal adjustment device is a heating device and the second thermal adjustment device is a heating device. In an alternative embodiment, the first thermal adjustment device is a cooling device and the second thermal adjustment device is a cooling device.

Having two thermal adjustment devices enables controlling the temperature of the growing liquid in detail and also providing different temperatures in different parts of the system. Further, having a heating device and a cooling device enables controlling the temperature such that the temperature of the growing liquid may be both increased and decreased depending on the need.

In one embodiment, the growing chamber is provided with a thermal insulation arranged to thermally insulate the closed chamber space.

In one embodiment the thermal insulation is provided to the growing chamber walls. The thermal insulation 14 may be a characteristic of the material of the growing chamber walls. Thus, the thermal insulation is integral part of the growing chamber walls.

In an alternative embodiment, the thermal insulation or a thermal insulation layer is provided to the growing chamber walls.

In one embodiment, the thermal insulation is a separate insulation layer provided on the inner surface or outer surface or inside the growing chamber walls. In another embodiment, the thermal insulation or thermal insulation layer is provided inside the growing chamber walls between the inner surface and outer surface of the growing chamber walls.

The thermal insulation of the growing chamber enables maintaining desired temperature inside the growing chamber and also maintaining desired temperature of the growing liquid inside the growing chamber. Effects of temperature variations in the surroundings of the aeroponic farming system may be minimized inside the growing chamber. Further, efficiency of the system may be increased as the thermal energy escaping from the growing chamber is minimized or decreased.

The present invention relates also to a method for aeroponic farming of plants having an aerial shoot and an underground root part. The aeroponic farming method being carried with an aeroponic farming system comprising a growing chamber having growing chamber walls defining a closed chamber space for accommodating the root part of the plant. The growing chamber walls are non-transparent for preventing light entering to the closed chamber space and thus the closed chamber space may be kept dark and without light.

The method for aeroponic farming comprises spraying growing liquid in the closed chamber space to the root part of the plant with one or more growing liquid nozzles. The method further comprises adjusting temperature inside the closed chamber space of the growing chamber by adjusting temperature of the growing liquid.

Accordingly, the temperature inside the growing chamber is adjusted by adjusting temperature of the growing liquid.

In one embodiment, the method comprises adjusting the temperature of the growing liquid sprayed the in closed chamber space for adjusting the temperature of the inside the closed chamber space. In this embodiment, the temperature of the growing liquid sprayed with the one or more growing liquid nozzles is adjusted upon, during or prior to spraying the growing liquid. Thus, the growing liquid is sprayed to the root part of the plant at the desired temperature for adjusting the temperature inside the growing chamber.

In one embodiment, the method comprises collecting excessive sprayed growing liquid inside the closed chamber space of the growing chamber to a growing liquid reservoir. The method also comprises adjusting temperature of the growing liquid collected to the growing liquid reservoir in the growing liquid reservoir for adjusting the temperature of the inside the closed chamber space. Accordingly, in this embodiment temperature of the growing liquid is adjusted inside the growing liquid reservoir. Thus, the growing liquid reservoir and the growing liquid in the growing liquid reservoir provides a thermal storage and facilitates maintaining constant or desired temperature.

In one embodiment, the method comprises collecting excessive sprayed growing liquid inside the closed chamber space of the growing chamber to the growing liquid reservoir and circulating the collected growing liquid from the growing liquid reservoir to one or more growing liquid nozzles. The method further comprises adjusting the temperature of the circulated growing liquid for adjusting the temperature of the inside the closed chamber space.

Accordingly, temperature of the growing liquid is adjusted during circulating the growing liquid from the growing liquid reservoir to the one or more growing liquid nozzles. Thus, the growing liquid may be sprayed at desired temperature and the temperature of the growing chamber may also be adjusted to desired value by utilizing the spraying.

According to the above mentioned, the method for aeroponic farming is carried out with an aeroponic farming system as described above.

An advantage of the invention is that adjusting the temperature inside the growing chamber is efficient when the growing liquid is utilized for the temperature adjustment. Furthermore, liquid material, especially water based liquid material, has high specific heat capacity which enables maintaining the temperature inside the growing chamber constant or at desired value. This is especially advantageous when the growing chamber comprises the growing liquid reservoir acting as thermal accumulator.

### BRIEF DESCRIPTION OF THE DRAWINGS

The invention is described in detail by means of specific embodiments with reference to the enclosed drawings, in which

FIG. 1 shows schematically an aeroponic growing system according one embodiment to the present invention;

FIG. 2 shows schematically a side view of the aeroponic growing system of FIG. 1;

FIG. 3 shows schematically an end view of the aeroponic growing system of FIG. 1;

FIG. 4A shows schematically a growing chamber of an aeroponic farming system according to one embodiment of the present invention;

FIG. 4B shows schematically a partitioning wall of a growing chamber of an aeroponic farming system according to one embodiment of the present invention;

FIGS. 4A, 4B, 5, 6, 7, 8B, 8A, 9A, 9B, 10 and 11 show different embodiments of the growing chamber of an aeroponic farming system according to the present invention.

### DETAILED DESCRIPTION OF THE INVENTION

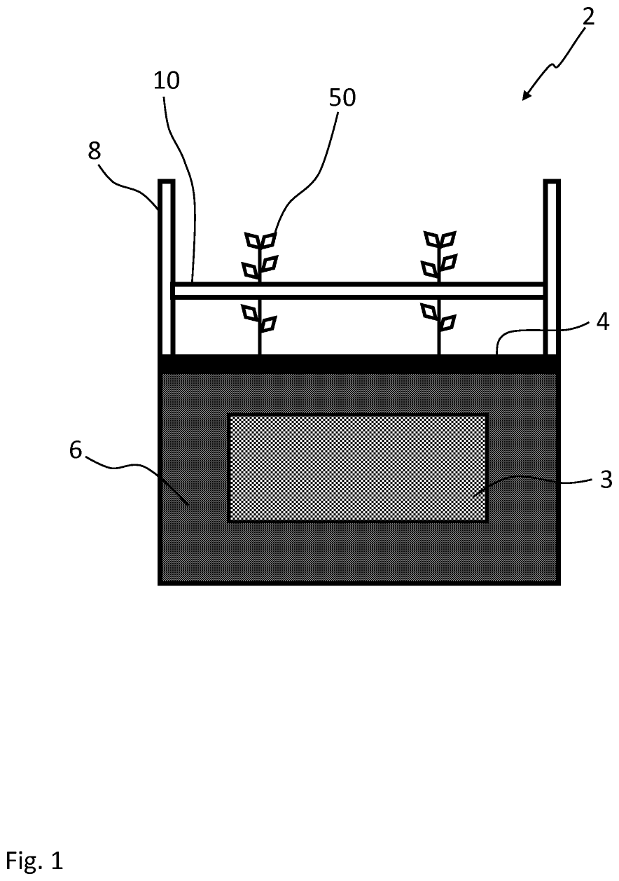

FIG. 1 shows schematically one embodiment of an aeroponic farming system 2. The aeroponic farming system 2 comprises a plant support base 4 to which plants 50 are supported. The aeroponic farming system 2 further comprises an upper plant support 8, 10 provided above, or on a first side, of the plant support base 4. The aeroponic farming system 2 further comprises growing chamber 6 provided under, or on a second side, of the plant support base 4.

The plant support base 4 comprises a plant support surface and may be provided as plant support plane or plant support plate or plant support layer.

In the embodiment shown in the figures, the plant support base 4 is arranged substantially horizontally. The upper plant support 8, 10 is provided in vertical direction above the plant support base 4. The growing chamber 6 is provided in vertical direction under the plant support base 4.

It should be noted, that in alternative embodiments the plant support base 4 may be arranged in angle to the horizontal direction or inclined or even in vertical direction. Therefore, the upper plant support 8, 10 is provided on the first side of the plant support base 4 and the growing chamber 6 is provided on the second side of the plant support base 4.

The upper plant support 8, 10 and the growing chamber 6 are arranged on opposite sides the plant support base.

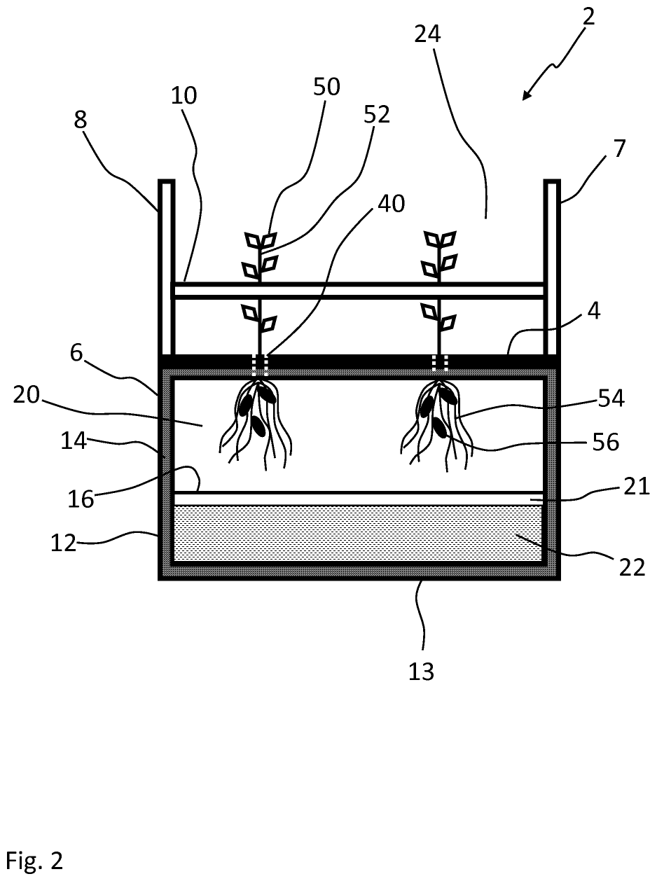

FIG. 2 shows schematically a front view of the aeroponic farming system 2 of FIG. 2, plants 50 supported to the aeroponic farming system 2 and the structure of the growing chamber 6 inside the growing chamber 6.

The plant 50 comprise an aerial shoot 52, or stem. The aerial shoot 52 means upper part of the plant 50 growing on or above ground and receiving light in natural growing environment. The plant 50 further comprises a root part 54, or roots. The root part 54 means lower part of the plant growing underground and not receiving light in natural growing environment. Accordingly, the root part 54 is growing in the soil of the ground and the aerial shoot 52 extends from the ground.

As shown in FIG. 2, the root part 54 of the plant 50 comprises tubers 56 which may be potatoes, yams, sweet potatoes or the like. Further, the plant 50 may be root vegetable plant and the root part 54 may be formed as a root vegetable.

The aeroponic farming system 2 or method for aeroponic farming according to the present invention are most suitable for tuber plants and root vegetable plants. However, the aeroponic farming system 2 and method may also be used for farming any other plants having the root part 54 and the aerial shoot 52.

The plant support base 4 comprises one or more support openings or receptacles 40 providing a through-hole through plant support base 4. The support openings 40 extend through the plant support base from the first side to the second side of the plant support base 4.

The plant support base 4 is arranged to support the plant 50 such that the plant extends through the plant support base 4 via the support opening 40 and such that the aerial shoot 52 is arranged on the first side of the plant support base 4 and the root part 54 is arranged on a second side the plant support base. Thus, in FIG. 2, the aerial shoot 52 extends from the plant support base 4 above the plant support base 4 and the root part 54 extends from the plant support base 4 under the plant support base 4.

The upper plant support 7, 8, 10 is provided on the first upper side of the plant support base 4 for supporting the aerial shoot 52 of the plant 50.

Accordingly, the upper plant support 7, 8, 10 comprises support members 7, 8, 10 arranged to support aerial shoot 52 of the plant 50.

In the embodiments of figures, the upper plant support 7, 8, 10 is connected, attached or supported to the aeroponic farming system 2 or the plant support base 4 or the growing chamber 6. Accordingly, the upper plant support 7, 8, 10 is integral part of the aeroponic farming system 2.

In alternatively embodiments, the upper plant support 7, 8, 10 is a separate structure which is provided separate from the plant support base 4 and the growing chamber 6 and separate from other structures of the aeroponic farming system 2. The separate upper support 7, 8, 10 is in some embodiments surrounding the plant support base 4 and/or the growing chamber 6. Thus, the upper plant support 7, 8, 10 is supported and extending from or standing on a floor or ground. Alternatively, the upper plant support 7, 8, 10 is arranged above the plant support base 4 and/or the growing chamber. Thus, the upper plant support 7, 8, 10 is attached or supported to a ceiling or other structures of building or room (not shown).

The aerial shoot 52 of the plant 50 extends from the plant support base 4 and is arranged to an aerial growing space or aerial growing environment 24. Properties of the aerial growing space 24 may be controlled during aeroponic farming.

In the embodiments of the figures, the upper plant support and the aerial growing space 24 are formed as open structures. Accordingly, light, humidity and gases may enter the aerial growing space 24 from the surroundings of the aeroponic farming system 2. In alternative embodiments, the upper plant support 7, 8, 10 is provided as upper chamber or is arranged to form the upper chamber (not shown). The upper chamber provides a closed upper chamber having closed aerial growing space 24 into which the aerial shoot 52 of the plant extends from the plant support base 4. The plant support base 4 forms one wall, for example a bottom wall, of the upper chamber. The aerial shoot 52 grows inside the closed upper space 24.

The growing chamber 6 is provided under the plant support base 4, or on the second side of the plant support base 4. The growing chamber 6 comprises growing chamber walls 12, 13 forming a closed growing chamber. The growing chamber 6 further comprises growing chamber door 3, as shown in FIG. 1. The growing chamber door 3 may be arranged in closed position and open position. In the closed position of the growing chamber door 3, the growing chamber 6 forms a closed chamber space inside the growing chamber 6. In the open position of the growing chamber door 3, the inner growing chamber space is accessible via opening of the growing chamber door 3.

The plant support base 4 forms the growing chamber top wall or at least part of the growing chamber top wall. Thus, the root part 54 of the plant 50 extends from the plant support base 4 and the support opening 40 thereof into the closed growing chamber 6, as shown in FIG. 2.

The growing chamber 6 is provided and arranged directly below or adjacent the plant support base 4.

The growing chamber walls 12, 13, 4 define a closed chamber space inside the growing chamber 6. The growing chamber walls 12, 13, 4 are further made of non-transparent material or they comprise a layer of non-transparent material. Accordingly, the growing chamber walls 12, 13 4 provide a dark atmosphere inside the growing chamber 6 such that light cannot enter inside growing chamber 6 from surroundings of the aeroponic farming system 2. Thus, the growing chamber walls 12, 13, 4 are non-transparent.

The growing chamber 6 and the growing chamber walls 12, 13, 4 may be formed from any suitable material. Preferably, the growing chamber is made of waterproof material or comprises a waterproof layer and/or light barrier layer or some other suitable material layers.

In one embodiment, the growing chamber 6 and the growing chamber walls 12, 13, 4 are at least partly made of microfiber cellulose material, biocomposite material or some other composite material or biodegradable material. Biocomposite materials are composite material formed by a matrix (resin) and a reinforcement of natural fibers. Microfibre cellulose materials comprise nanostructured cellulose comprising nanosized cellulose fibrils. Typical fibril widths are 5-20 nanometers with a wide range of lengths, typically several micrometers.

The growing chamber 6 may be a moulded element such that the side walls 12, bottom wall 13 and possibly also the plant support base 4 form one integral element.

The growing chamber 6 is provided with thermal insulation 14 for insulating the inner space of the growing chamber 6 thermally from the surroundings of the aeroponic farming system 2.

In the embodiment of FIG. 2, the thermal insulation 14 is provided to the growing chamber walls 12, 13, 4. The thermal insulation 14 may be a characteristic of the material of the growing chamber walls 12, 13, 4. Thus, the thermal insulation is integral part of the growing chamber walls 12, 13, 4.

Alternatively, the thermal insulation or thermal insulation layer 14 is provided to the growing chamber walls 12, 13, 4. In one embodiment, the thermal insulation 14 is a separate insulation layer provided on the inner surface or outer surface or inside the growing chamber walls 12, 13, 4. In another embodiment, the thermal insulation 14 or thermal insulation layer is provided inside the growing chamber walls 12, 13, 4 between the inner surface and outer surface of the growing chamber walls 12, 13, 4.

As shown in FIG. 2, the growing chamber 6 and the growing chamber walls 12, 13, 4 define a closed growing chamber space inside the growing chamber 6. The growing chamber further comprises a partitioning wall 16 arranged inside the growing chamber 6. The partitioning wall 16 is arranged to divide the closed growing chamber space into an upper growing space 20 and a lower liquid space 21. The partitioning wall 16 is arranged between the plant support base 4 and the bottom wall 13 of the growing chamber 6 such that the partitioning wall 16 divides the growing chamber space to the upper growing space 20 and the lower liquid space in the direction between the plant support base 4 and the bottom wall 13 of the growing chamber 6.

The partitioning wall 16 extends between the side walls 12 of the growing chamber 6. The partitioning wall 16 is preferably supported or connected to side walls 12.

In the embodiment of FIG. 2, the partitioning wall 16 extends in horizontal direction. Further, the partitioning wall 16 extends parallel to the plant support base 4.

Accordingly, the upper growing space 20 is provided between the plant support base 4 and the partitioning wall 16 for enclosing the root part 54 for of the plant 50.

The lower liquid space 21 is provided between the partitioning sheet 16 and a bottom wall 13 of the growing chamber 6 for retaining growing liquid 22. The side walls 12 and the bottom wall 13 or the growing chamber walls 12, 13, 4 are made of waterproof or liquid proof material such that the growing chamber 6 forms a container or growing liquid reservoir for storing or retaining growing liquid 22. Growing liquid is further sprayed to the root part 54 of the plant 50.

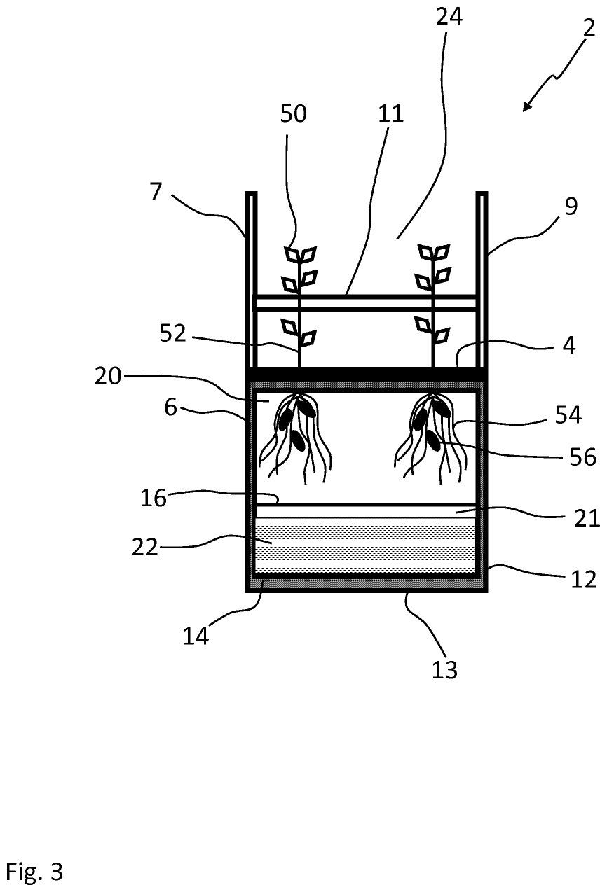

In the embodiment of FIGS. 2 and 3, the lower liquid space 21 is arranged to retain or store growing liquid 22. Thus, growing liquid 22 is stored inside the growing chamber 6 below the partitioning wall 16 and in the lower liquid space 21 between the partitioning wall 16 and the bottom wall 13 of the growing chamber 6. Thus, the lower liquid space 21 forms the growing liquid reservoir inside the growing chamber 6. Further, the side walls 12 and the bottom wall 13 are arranged form the growing liquid reservoir inside the growing chamber 21.

Accordingly, the side walls 12 are made or provided waterproof at least on the area or height between the bottom wall 13 and the partitioning wall 16. The bottom wall 13 is made waterproof. Waterproof is provided by a separate waterproof barrier or layer or it is a property of the material of the side walls 12 and the bottom wall 13.

FIG. 3 shows schematically a side end view of the aeroponic farming system 2 of FIG. 2.

In the embodiment of FIGS. 2 and 3, the upper plant support comprises vertical support elements 7, 8, 9 and horizontal support elements 10, 11 for supporting the aerial shoot 52 of the plant 50. The aerial shoot 52 may be attached or connected to the upper plant support for supporting and keeping the aerial shoot 52 in upright position. As the root part 54 is not in soil or ground, the root part cannot provide necessary support for the aerial shoot 52.

It should be noted that the upper plant support may be implemented in various ways for supporting the aerial shoot 52. Thus, the present invention is not restricted to any special configuration of upper plant support.

Furthermore, the in some embodiment of the present invention the partitioning wall 16 may be omitted. The partitioning wall 16 is not required with the circulation arrangement, or in other embodiments, but may be preferable for dividing the chamber space of the growing chamber 6.

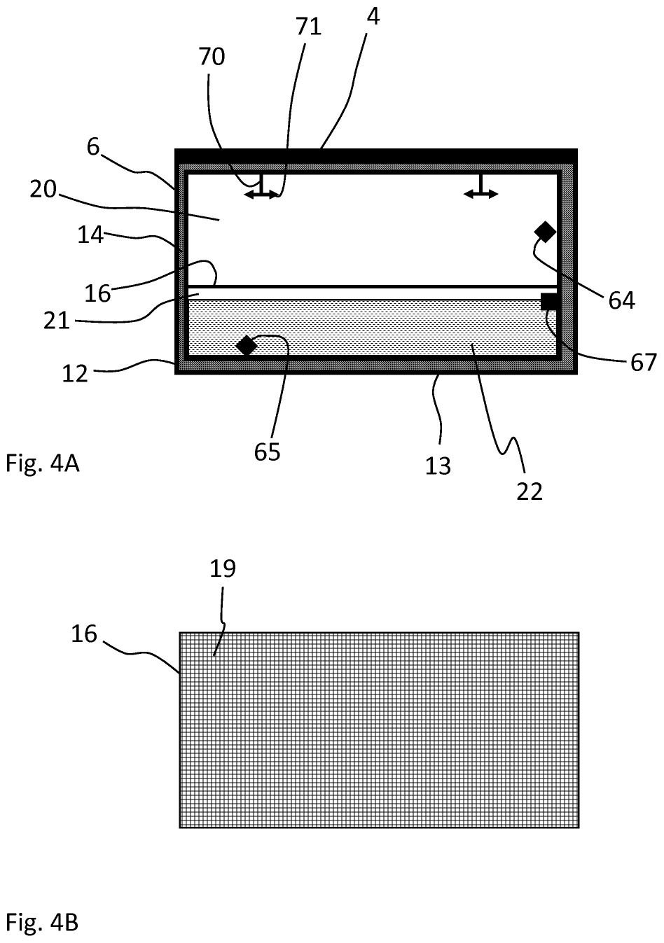

FIG. 4A shows schematically one embodiment of the growing chamber 6. The growing chamber 6 comprise the bottom wall 13, the top wall 4 and side walls 12 extending between the bottom wall 13 and the top wall 4. The top wall 4 is provided as the plant support base 4 or at least part of it. Accordingly, the plant support base 4 forms the top wall of the growing chamber 6 or the plant support base 4 forms at least part of the top wall of the growing chamber 6.

The growing chamber 6 is provided with one or more growing liquid nozzles 70, 71. The growing liquid nozzles 70, 71 are arranged to spray growing liquid to the upper growing space 20 of the growing chamber 6 to the root part 54 of the pant 50. The growing liquid nozzles 70, 71 are arranged to atomize and spray atomized growing liquid to the upper growing space 20. The growing liquid nozzles 70, 71 may be any kind of known spray nozzles.

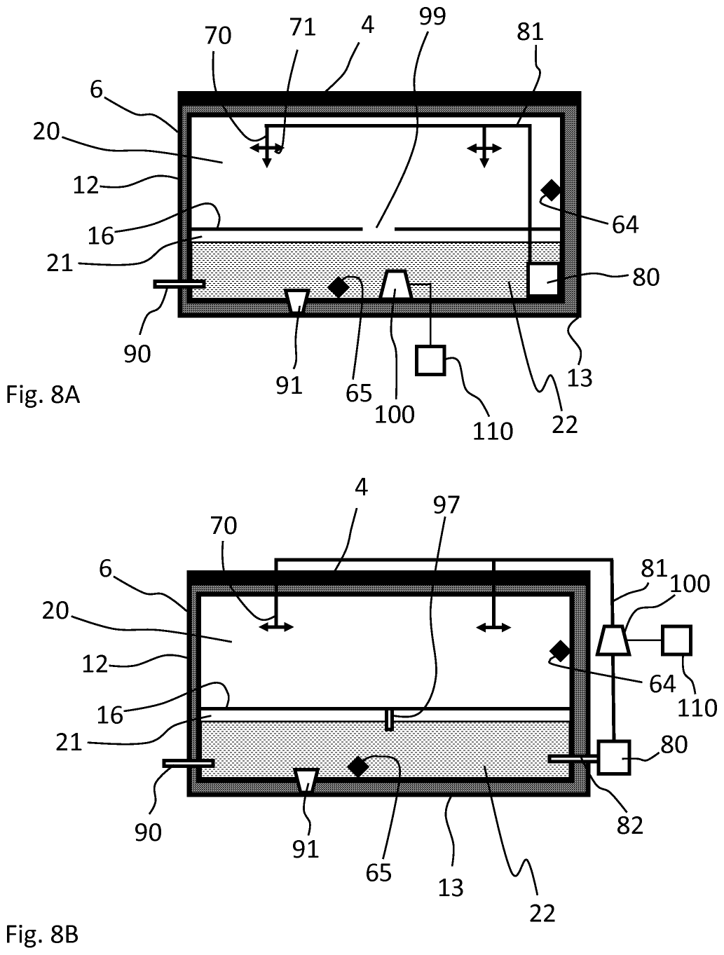

The growing liquid nozzle 70 comprises a nozzle head 71 from which the growing liquid is discharged out of the growing liquid nozzle 70. The growing liquid nozzle 70 or the nozzle head 71 thereof is arranged to spray growing liquid in horizontal direction and/or parallel to the plant support base 4, as shown in FIG. 4A. However, in some embodiment, the growing liquid nozzles 70 or the nozzle heads 71 thereof are arranged to spray growing liquid in vertical direction upwards or downwards or transversely or perpendicularly to the plant support base 4, as shown in FIG. 8A. Further alternatively, the growing liquid nozzles 70 or the nozzle heads 71 thereof may be arranged to spray growing liquid in an angle between vertical and horizontal direction.

The growing liquid nozzles 70, 71 are supported to the top wall or the plant support base 4. Thus, the growing liquid nozzles 70, 71 are supported to the structures of the growing chamber 6.

In the embodiment of the figures, the one or more growing liquid nozzles 70, 71 are arranged or placed to the upper growing space 20 and arranged to spray growing liquid to the upper growing space 20 of the growing chamber 6.

In an alternative embodiment, the one or more growing liquid nozzles 70 may be arranged outside the upper growing space 20 such that the nozzle head 71 opens into the upper growing space 20 and/or is arranged to spray growing liquid to the upper growing space 20 of the growing chamber 6. Thus, the growing liquid nozzle 70 may be arranged at least partly to the lower liquid space 21 or embedded to side wall 12 or the top wall 4 of the growing chamber 6.

Furthermore, in embodiments in which the partitioning wall 16 is omitted, the growing liquid nozzles 70, 71 are arranged to the spray growing liquid into the closed chamber space 20 of the growing chamber 6. Preferably, the growing liquid nozzles 70, 71 are arranged to the spray growing liquid in upper part of the closed chamber space 20 or close to the plant support base 4 for spraying the root part 54 of the plant 50.

The growing chamber 6 comprises a first chamber temperature sensor 64 arranged to the upper growing space 20 and arranged to measure temperature in the upper growing space 20.

The growing chamber 6 is further provided with a second chamber temperature sensor 65 provided to the lower liquid space 21 and arranged to measure temperature of the growing liquid 22 in the lower liquid space 21 or in the growing liquid reservoir in the lower liquid space 21.

The first and second chamber temperature sensors 64, 65 may be attached or supported to the growing chamber walls 12, 13, 4.

The first and second chamber temperature sensors 64, 65 may be any known kind of temperature sensors.

The growing chamber 6 is further provided with a chamber humidity sensor 66 arranged to measure humidity in upper growing space 20. The chamber humidity sensor 66 may be any know kind of humidity sensor. The chamber humidity sensor 66 is preferably connected directly or indirectly to the growing liquid nozzles 70 for controlling and adjusting the growing liquid nozzles 70 and spraying of growing liquid based on the measurements with the chamber humidity sensor 66. Thus, the measurements with the chamber humidity sensor 66 is utilized for adjusting operation of the growing liquid nozzles 70.

The chamber humidity sensor 66 is arranged to the upper growing space 20 or arranged to measure humidity in the upper growing space 20. The chamber humidity sensor 66 may be attached or supported to the attached or supported to the growing chamber walls 12, 13, 4.

The growing chamber 6 is provided with a surface lever sensor 67 arranged to measure the surface level of the growing liquid 22 in the lower liquid space 21, as shown in FIG. 4A. The surface level sensor 67 is arranged to the lower liquid space 21 or arranged to measure growing liquid level in the lower liquid space 21. The surface level sensor 67 may be any known surface level sensor.

The inner growing chamber space is divided to the upper growing space 20 and the lower liquid space 21 with the partitioning wall 16, as shown in FIG. 4A.

FIG. 4B shows one embodiment of the partitioning wall 16. The partitioning wall 16 is a grid sheet, net sheet or fabric sheet comprising pores, holes or meshes 19 extending through the partitioning wall 16 in thickness direction. Accordingly, the partitioning wall 16 is made of liquid and gas permeable material or with liquid or gas permeable structure. Accordingly, the partitioning wall 16 comprises a structure or is made of material allowing excessive growing liquid 22 flow through the partitioning wall 16 from the upper growing space 20 to the lower liquid space 21. Accordingly, the excessive growing liquid may be collected to the lower liquid space 21 and the root part 54 may be prevented from being in contact with excessive growing liquid. Further, the humidity in the upper growing space 21 may be kept under 100%. Thus, the excessive growing liquid flows through the partitioning wall 16 to the growing liquid reservoir in the lower liquid space 21.

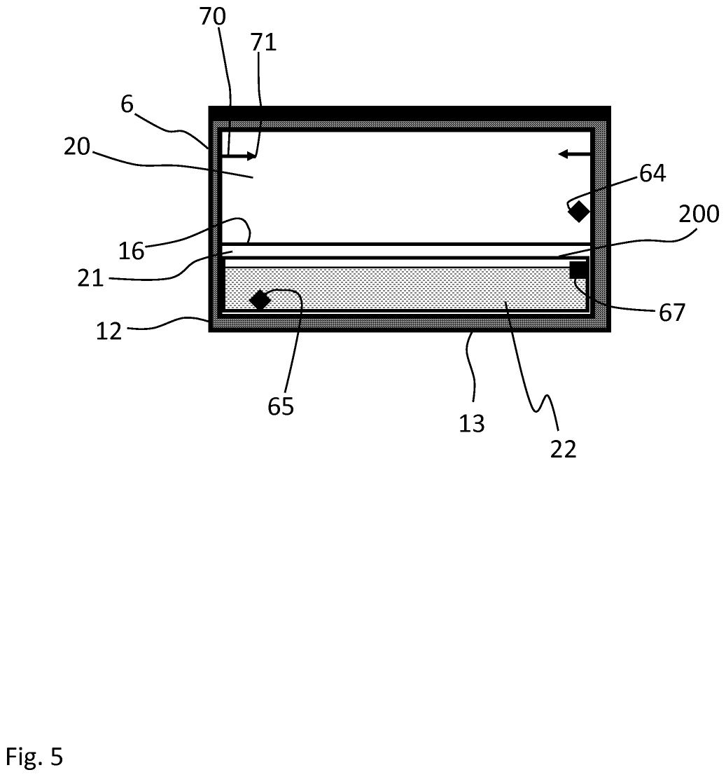

FIG. 5 shows an alternative embodiment of the growing chamber 6. The growing chamber 6 and the lower liquid space 21 is provided with a separate growing liquid reservoir 200 arranged below the partitioning wall 16. The separate growing liquid reservoir 200 is arranged to store the excessive growing liquid 22 flowing from the upper growing space 20. The separate growing liquid reservoir 200 is made of waterproof material for keeping the growing liquid 22 inside. The separate growing liquid reservoir 200 may have an open top wall enabling the excessive growing liquid to enter from the upper growing space 20.

It should be noted, that the separate growing liquid reservoir 200 may also be provided in embodiments in which the partition wall 16 is omitted. The separate growing liquid reservoir 200 is arranged below the plant support base 4 and/or at lower part of the closed chamber space 20.

The second chamber temperature sensor 65 is arranged to the separate growing liquid reservoir 200 for measuring the temperature of the growing liquid 22 inside the separate growing liquid reservoir 200.

The surface level sensor 67 is also arranged to the separate growing liquid reservoir 200 for measuring surface level or amount of the growing liquid 22 inside the separate growing liquid reservoir 200.

In the embodiment of FIG. 5, the partitioning wall 16 corresponds the partitioning wall 16 of FIG. 4A.

The growing liquid nozzles 70 are arranged or supported to the side walls 12 of the growing chamber 6 in the upper growing space 20. Further, the growing liquid nozzles 70 are arranged to spray growing liquid in horizontal direction or parallel to the plant support base 4 in to the upper growing space 20.

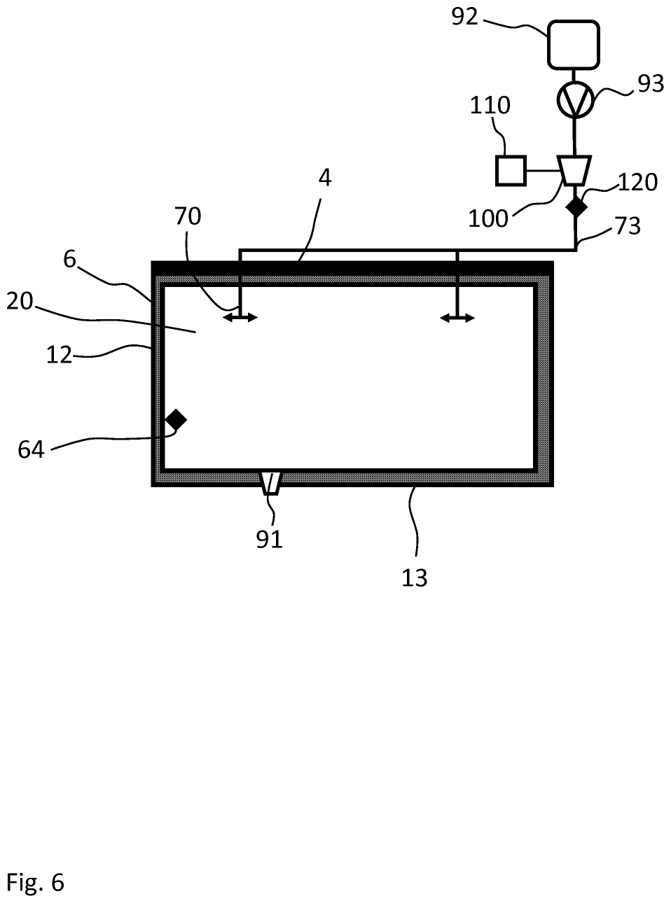

FIG. 6 shows one embodiment of the present invention. The partitioning wall 16 is omitted and the growing chamber 6 comprises the closed chamber space 20 inside the growing chamber 6.

The growing liquid nozzles 70, 71 are arranged inside the closed chamber space 20 of the growing chamber 6.

The growing chamber 6 comprises the first chamber temperature sensor 64 arranged to the closed chamber space 20 and arranged to measure temperature in the closed chamber space 20.

The growing chamber of FIG. 6 may be also provided with the chamber humidity sensor 66 for measuring arranged to measure humidity in the upper growing space 20.

The aeroponic farming system 2 or the growing chamber 6 of FIG. 6 is provided with a growing liquid outlet arrangement 91 or growing liquid outlet 91 arranged to discharge growing liquid 22 from the growing chamber 6. The growing liquid outlet arrangement 91 is provided to the bottom wall 13 of the growing chamber 6. Alternatively, the growing liquid outlet arrangement may be provided to side wall 12 of the growing chamber 6. Thus, growing liquid may be discharged from the aeroponic farming system 2 by discharging growing liquid from the closed chamber space 20.

The growing liquid outlet arrangement 91 may be arranged the discharge growing liquid form the growing chamber 6 continuously such that growing liquid is not collected or stored inside the growing chamber 6.

Alternatively, the side walls 12 and the bottom wall 13 of the growing liquid chamber 6 are arranged to form the growing liquid reservoir for storing growing liquid inside the growing liquid chamber 6. Accordingly, the growing liquid outlet arrangement 91 may be user occasionally or at predetermined intervals for changing growing liquid in the growing liquid reservoir.

Further, in the embodiment of FIG. 6, the growing chamber 6 may be provided with the separate growing liquid reservoir 200 arranged inside the closed chamber space 20.

In the embodiment of FIG. 6, the system 2 comprises growing liquid source or growing liquid container 92. Growing liquid is supplied to the growing liquid chamber 6 from the growing liquid source 92 by a supply pump 93 via a growing liquid supply channel 73. The growing liquid supply channel 73 extends from between the growing liquid source 92 and the growing liquid nozzles 70, 71. The supply pump 93 is arranged in connection with or to the supply channel 73. Alternatively, the supply pump 93 may be arranged in connection with or to the growing liquid source 92.

The system 2 comprises an inlet arrangement of the system. The inlet arrangement comprises the supply channel 73, or supply channel 73 and the supply pump 93 or supply channel 73, the supply pump 93 and the growingly quid source 92.

It should be noted that the inlet arrangement and components thereof may vary depending on the embodiment of the present invention.

Further, in the embodiment of FIG. 6, the inlet arrangement is connected to the growing liquid nozzles 70.

In this embodiment, the supply channel 73 extends outside or is arranged to extend outside the growing chamber 6. As shown in FIG. 6, the supply channel 81 extends outside the growing chamber 6 from the growing liquid source 92 to the growing liquid nozzles 70. The supply channel 73 further extends through the growing chamber wall or the plant support base 4 and is connected to the growing liquid nozzles 70.

It should be noted, that the growing liquid source 92, the supply pump 93 and the supply channel may also be provided inside the growing chamber 6.

In the present invention and in the context of this application, the system 2 comprises thermal adjustment device 100, 101, 102 arranged to adjust the temperature of the growing liquid 22 in the system 2. The thermal adjustment device 100 may be a heat exchanger, heating device, cooling device or combined heating and cooling device implemented as any known type of device for controlling temperature of liquid material. The thermal adjustment device 100, 101, 102 may comprise heater, such as electric heater or liquid heater, and/or cooler, such as electric cooler or liquid cooler. The thermal adjustment device 100 may comprise a heat exchanger arranged exchange temperature between the growing liquid 22 in the system 2 and a working fluid. Adjusting the temperature of the working fluid, liquid or gas, or flow rate of the growing liquid 22 and/or the working fluid in the heat exchanger 100, 101, 102, the temperature of the growing liquid may be adjusted. The thermal adjustment device 100, 101, 102 may also be a heat transfer element or thermoelement. Accordingly, the thermal adjustment device 100, 101, 102 may be any known kind of device or element arranged to adjust temperature of the growing liquid in the system 2.

The thermal adjustment device 100, 101, 102 may be connected to a power source 110, 111, 112 for adjusting the operation and/or temperature of the growing liquid. The power source 110, 111, 112 may be electric power source for operating the electric heater or cooler, or a liquid power source or heat or cold source for providing heated or cooled working fluid to the heat exchanger 100, 101, 102.

In the embodiment of FIG. 6, The system 2 further comprises a thermal adjustment device 100 provided in connection with or to the inlet arrangement.

Further, the thermal adjustment device 100 is provided to or in connection with the growing liquid supply channel 73 connected to the one or more growing liquid nozzles 70, 71. Thus, the thermal adjustment device 100 is arranged to adjust temperature of the growing liquid in the supply channel 73. Thus, the thermal adjustment device 100 is arranged to adjust temperature of the growing liquid 22 sprayed from the growing liquid nozzles 70, 71 to the closed chamber space 20. Further, the thermal adjustment device 100 is arranged to adjust the temperature of the growing liquid upstream of the growing liquid nozzles 70 and/or before spraying the growing liquid with the growing liquid nozzles 70 to the closed chamber space 20.

In the embodiment of FIG. 6, the thermal adjustment device 100 is arranged downstream of the supply pump 93 and between the supply pump 93 and the growing chamber 6 or the growing liquid nozzles 70.

Alternatively, the thermal adjustment device 100 may arranged upstream of the supply pump 93 and between the growing chamber source 92 and the supply pump 93.

In the embodiment of FIG. 6, the thermal adjustment device 100 may be heating device for heating the growing liquid, a cooling device for cooling the growing liquid or a combined heating and cooling device for heating and cooling the growing liquid.

The thermal adjustment device 100 is connected to the power source 110 or heat and/or cold source for operating the thermal adjustment dev ice 100.

The inlet arrangement may further be provided with a third temperature sensor 120. In FIG. 6, the third temperature sensor 120 is arranged in connection with or to the supply channel 73 and downstream of the thermal adjustment device 100. Further, the third temperature sensor 120 is arranged between the thermal adjustment device 100 and the growing chamber 6 or the growing liquid nozzles 70.

The third temperature sensor 120 is connected to the power source 110 or the thermal adjustment device 100. Further, also the first temperature sensor 64 may be connected to the power source 110 or the thermal adjustment device 100. Thus, the thermal adjustment device 100 or the power source 110, and further the temperature of the growing liquid, are controlled based on the measurement results of the first temperature sensor 64 or based on the first and third temperature sensors 64, 120.

The system 2 may also comprise a control unit (not shown), such as computer or processor unit, for controlling the thermal adjustment device 100. The first and/or third temperature sensors and the thermal adjustment device and/or the power source 110 are connected to the control unit.

Alternatively, the third temperature sensor 120 may be arranged in connection with or to the supply channel 73 and upstream of the thermal adjustment device 100. Further, the third temperature sensor 120 may arranged between the growing liquid source 92 and the thermal adjustment device.

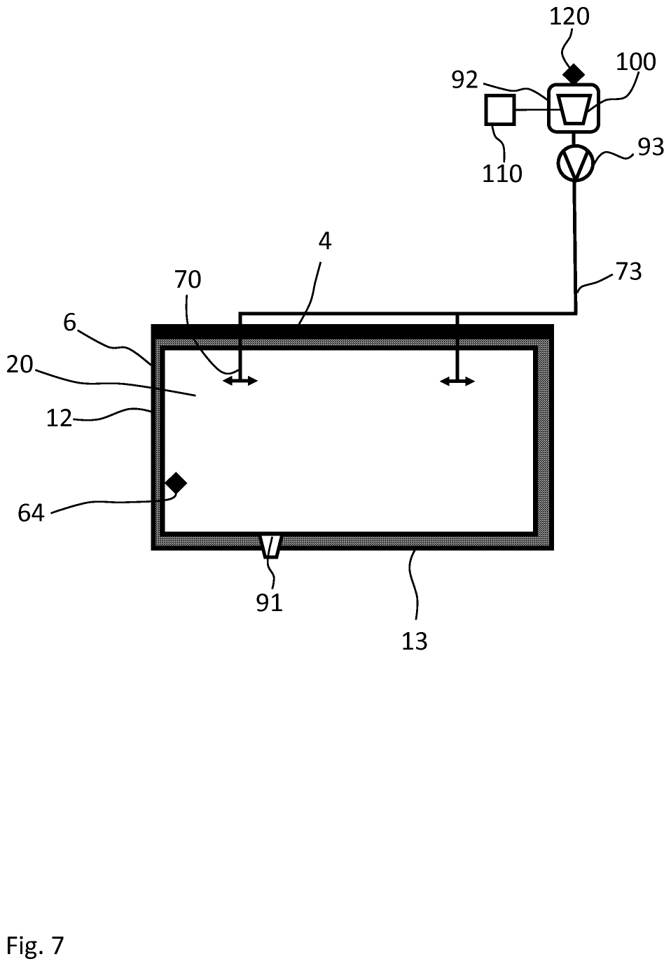

FIG. 7 shows another embodiment, in which the thermal adjustment device 100 is arranged in connection with or to the growing liquid source 92 or container. Accordingly, the thermal adjustment device 100 is arranged to adjust the temperature of the growing liquid in the growing liquid source 92. Accordingly, temperature the growing liquid supplied to the growing liquid nozzles 70 via the supply channel 73 is adjusted upstream of the growing chamber 6 or the growing liquid nozzles 70 and before spraying the growing liquid into the closed chamber space 20. Accordingly, the growing liquid may be maintained or adjusted to desired temperature in the growing liquid source 92.

In this embodiment, the third temperature sensor 120 is arranged in connection with or to the growing liquid source 92 for measuring the temperature of the growing liquid in the growing liquid source 92. The third temperature sensor 120 may be connected to the power source 110 or the thermal adjustment device 100. Further, also the first temperature sensor 64 may be connected to the power source 110 or the thermal adjustment device 100. Thus, the thermal adjustment device 100 or the power source 110, and further the temperature of the growing liquid in the growing liquid source 92, may be controlled based on the measurement results of the first temperature sensor 64 or based on the first and third temperature sensors 64, 120. Alternatively, the control unit (not shown) may be utilized for controlling the thermal adjustment device 100 and/or the power source 110, as in FIG. 6.

The other elements of the embodiment of FIG. 7 correspond the embodiment of FIG. 6.

FIG. 8A shows an alternative embodiment of the invention and the growing chamber 6. The growing chamber 6 comprises the partitioning wall 16 dividing the chamber space to the upper growing space 20 and the lower liquid space 21. In the embodiment of FIG. 8A, the partitioning wall 16 is made of liquid impermeable plate or liquid impermeable fabric material. The partitioning wall 16 is provided with a flow opening 99 open to the lower liquid space 21 and extending between the upper growing space 20 and the lower liquid space 21. The partitioning wall 16 may be further inclined relative to the horizontal direction towards the flow opening 99 such that the excessive growing liquid falling on the partitioning wall 16 in the upper growing space 20 flows via the flow opening 99 to the lower liquid space 21. The partitioning wall 16 is inclined relative to the horizontal direction towards the flow opening 99. Accordingly, in this embodiment, the growing liquid is prevented from penetrating or flowing through partitioning wall 16 as it is made of and provided as liquid impermeable material and structure. Thus, the growing liquid flows to the lower liquid space 21 or the liquid reservoir 200 via the flow opening 99.

In the embodiment of FIG. 8A the aeroponic farming system 2 or the growing chamber 6 is provided with a growing liquid inlet arrangement 90 arranged to supply growing liquid 22 into the growing chamber 6. In this embodiment, the growing liquid inlet arrangement 90 is connected to the growing chamber 6 and arranged to the supply growing liquid to the lower liquid space 21 of the growing chamber 6. Thus, the growing liquid inlet arrangement 90 is connected to the lower liquid space 21 or to the separate growing liquid reservoir 200. Therefore, new growing liquid may be added to the aeroponic farming system 2 by supplying growing liquid to the lower liquid space 21 or to the separate growing liquid reservoir 200.

The system 2 further comprises a liquid circulation arrangement arranged to supply growing liquid 22 from the lower liquid space 21 or from the growing liquid reservoir 200 to one or more of the growing liquid nozzles 70. Thus, the liquid circulation arrangement is arranged to supply growing liquid 22 from the lower liquid space 21 or the growing liquid reservoir 200 to upper growing space 20 by utilizing the one or more of the growing liquid nozzles 70.

FIG. 8A shows one embodiment of the liquid circulation arrangement 80, 81. The liquid circulation arrangement comprises a circulation pump 80 arranged to the lower liquid space 21 or to the separate growing liquid reservoir 200 and arranged to pump and supply growing liquid 22 from the lower liquid space 21 or the separate growing liquid reservoir 200 to the growing liquid nozzles 70 via a circulation channel 81. The circulation channel 81 is connected between the circulation pump 80 and the one or more growing liquid nozzles 70. The growing liquid nozzles 70 are arranged into the upper growing space 20.

Furthermore, in the embodiment of FIG. 8A, the liquid circulation arrangement 80, 81, the circulation pump 80 and the circulation channel 81 is arranged inside the growing chamber 6.

It should be noted that, the circulation arrangement may be utilized also in growing chambers 6 in which the partitioning wall 16 is omitted. Accordingly, in the context of this application the circulation arrangement is arranged to circulate growing liquid from the growing liquid reservoir 12, 13 or the separate growing liquid reservoir 200 to the growing liquid nozzles 70 to be sprayed to the root part of the plant inside the growing chamber 6.

In the embodiment of FIG. 8A, the thermal adjustment device 100 is arranged in connection with or to the growing liquid growing liquid reservoir 12, 3 or the separate growing liquid reservoir 200. Further, the thermal adjustment device 100 is arranged in connection with or to the lower liquid space 21. Accordingly, the thermal adjustment device 100 is arranged to adjust temperature of the growing liquid 22 stored and collected to the growing liquid growing liquid reservoir 12, 3 or the separate growing liquid reservoir 200. Therefore, temperature of the growing liquid supplied to the growing liquid nozzles 70 via the circulation arrangement 80, 81 is adjusted. Further, temperature of the growing liquid supplied to the growing liquid nozzles 70 via the circulation arrangement 80, 81 upstream of the growing chamber 6 or the growing liquid nozzles 70 and before spraying the growing liquid into the closed chamber space or to the upper growing space 20. Accordingly, the growing liquid may be maintained or adjusted to desired temperature inside the growing liquid chamber 6 and in the growing liquid reservoir 12, 13, 200 inside growing liquid chamber 6.

The growing chamber 6 comprises the first chamber temperature sensor 64 arranged to the upper growing space 20 and arranged to measure temperature in the upper growing space 20. The second chamber temperature sensor 65 is provided to the lower liquid space 21 and arranged to measure temperature of the growing liquid 22 in the lower liquid space 21 or in the growing liquid reservoir in the lower liquid space 21. Thus, the temperature of the growing liquid 22 is adjusted with the thermal adjustment device 100 based on the predetermined desired temperature values and the temperatures measured with the first and second temperature sensors 64, 65.

Adjusting the temperature of the growing liquid in the growing liquid reservoir 12, 13, 200 provides thermal accumulator inside the growing chamber 6.

FIG. 8B shows an alternative embodiment. In this embodiment, the liquid circulation arrangement 80, 81 is arranged outside or is arranged to extend outside the growing chamber 6. As shown in FIG. 8B, the circulation pump 80 is arranged outside the growing chamber 6. The system 2 and the growing chamber 6 is provided with a circulation outlet 82 extending from the growing chamber 6 to the circulation pump 80. The circulation outlet 82 is arranged between the lower liquid space 21 or the growing liquid reservoir 200 and the circulation pump 80 for supplying growing liquid outside the growing chamber 6. The growing liquid nozzles 70 are arranged inside the growing chamber 6 to the upper growing space 20. The circulation channel 81 extends outside the growing chamber 6 from the circulation pump 80 to the upper growing space 20. The circulation channel 81 further extends outside the growing chamber 6 between the circulation pump 80 and the growing liquid nozzles 70.

The circulation channel 81 further extends through the growing chamber wall or the plant support base 4 and is connected to the growing liquid nozzles 70.

The thermal adjustment device or devices 100 are be provided to or in connection with the circulation arrangement 80, 81 and outside the growing chamber 6 for adjusting the temperature of the growing liquid 22 to the sprayed by the growing liquid nozzles 70. Further, the thermal adjustment device or devices 100 are provided to or in connection with the circulation channel 81, as shown in FIG. 8B.

In the embodiment of FIG. 8B, the thermal adjustment device 100 is provided to or in connection with the circulation channel 81. Alternatively, the thermal adjustment device 100 may be provided to or in connection with the circulation pump 80. Further, the thermal adjustment device 100 may be provided to or in connection with the circulation pump 80 also in embodiment of FIG. 8A in which the circulation pump is arranged inside the growing chamber 6 and in the growing liquid reservoir 12, 13, 200.

In the embodiment of FIG. 8B, the partitioning wall 16 is made of liquid impermeable plate or liquid impermeable fabric material. The partitioning wall 16 is provided with a flow connection or flow channel 97 open to the lower liquid space 21 and extending between the upper growing space 20 and the lower liquid space 21. Accordingly, in this embodiment, the growing liquid is prevented from penetrating or flowing through partitioning wall 16 as it is made of and provided as liquid impermeable material and structure. Thus, the growing liquid flows to the lower liquid space 21 or the liquid reservoir 200 via the flow opening 99.

In the embodiment of the FIG. 8B, the flow channel or flow connection 97 extends inside the growing chamber 6 between the upper growing space 20 and the lower liquid space 21. Alternatively, the flow channel or flow connection 97 may extend outside the growing chamber 6 from the upper growing space 20 to the lower liquid space 21.

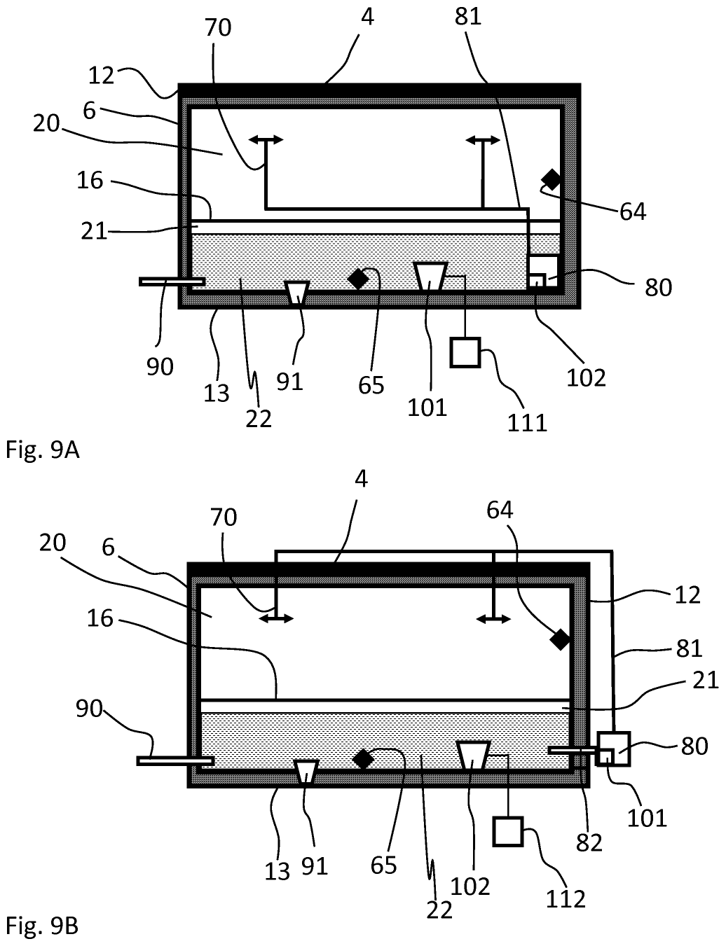

FIG. 9A shows a further embodiment, in which the liquid circulation arrangement 80, 81 is arranged inside the growing chamber 6. Accordingly, the circulation pump 80 is arranged to the lower liquid space 21. The growing liquid nozzles 70 are also arranged inside the growing chamber 6 to the upper growing space 20. The circulation channel 81 extends inside the growing chamber 6 from the lower liquid space 21 to the upper growing space 20. The circulation channel 81 further extends inside the growing chamber 6 between the circulation pump 80 and the growing liquid nozzles 70.

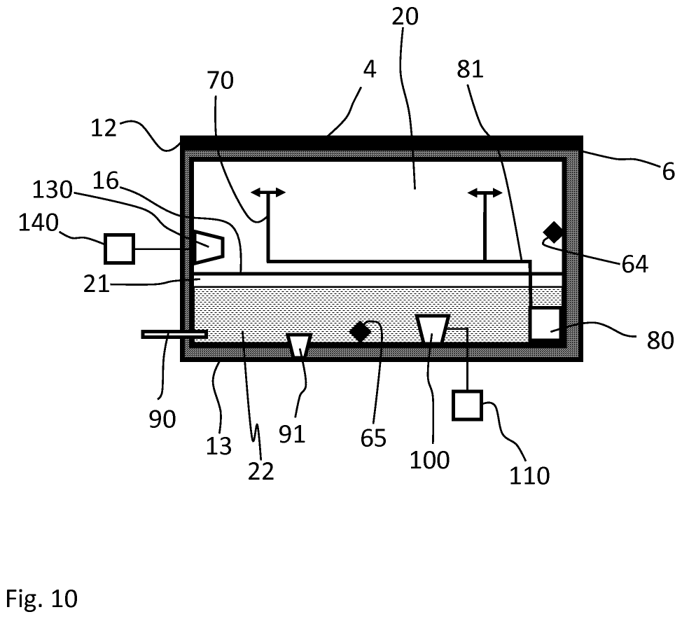

In the embodiment of FIG. 10A, the system 2 comprises a first thermal adjustment device 101 arranged inside the growing chamber 6 and to or in connection with the lower liquid space 21 for adjusting the temperature of the growing liquid 22 in the lower liquid space 21 or in the liquid reservoir 200. The first thermal adjustment device 101 is further connected to a first power source 111. The first thermal adjustment device 101 is provided as a heating device for heating the growing liquid 22 in the lower liquid space 21.

The system 2 further comprises a second thermal adjustment device 102 arranged inside the growing chamber 6. The second thermal adjustment device 102 is arranged to or in connection with the circulation pump 80 and arranged to adjust the temperature of the growing liquid when it is pumped or circulated from the lower liquid space 21 to the growing liquid nozzles 70 in the upper growing space 20.

In the embodiment of FIG. 9A, the second thermal adjustment device 102 is provided to or in connection with the circulation pump 80. Alternatively, the thermal adjustment device 100 may be provided to or in connection with the circulation channel 81.

In the embodiment of FIG. 9A, the first thermal adjustment device 101 is heating device and the second thermal adjustment device 102 is a cooling device.

In alternative embodiment, the first thermal adjustment device 101 is cooling device and the second thermal adjustment device 102 is a heating device.

In the embodiment of FIG. 10A, the growing liquid inlet arrangement 90 is arranged to supply growing liquid 22 into the growing chamber 6. In this embodiment, the growing liquid inlet arrangement 90 is connected to the growing chamber 6 and arranged to the supply growing liquid to the lower liquid space 21 of the growing chamber 6. Thus, the growing liquid inlet arrangement 90 is connected to the lower liquid space 21 or to the growing liquid reservoir 12, 13 200.

In this embodiment, the partitioning wall 16 is made of liquid permeable plate or liquid permeable fabric material.

FIG. 9B shows a further embodiment, in which the liquid circulation arrangement 80, 81 is arranged outside the growing chamber 6. The liquid circulation arrangement substantially corresponds the embodiment of FIG. 8B.

In the embodiment of FIG. 9B, the system 2 comprises a second thermal adjustment device 102 arranged inside the growing chamber 6. The second thermal adjustment device 102 corresponds the first thermal adjustment device 101 of FIG. 10A. The second thermal adjustment device 102 is connected to a second power source 112. The second thermal adjustment device 102 is provided as a cooling device for cooling the growing liquid 22 in the lower liquid space 21.

The system 2 further comprises a first thermal adjustment device 101 arranged outside the growing chamber 6. The first thermal adjustment device 101 is arranged to or in connection with the circulation pump 80 and arranged to adjust the temperature of the growing liquid when it is pumped or circulated from the lower liquid space 21 to the growing liquid nozzles 70 in the upper growing space 20.

In the embodiment of FIG. 9B, the first thermal adjustment device 101 is provided to or in connection with the circulation pump 80. Alternatively, the first thermal adjustment device 101 may be provided to or in connection with the circulation channel 81.

In the embodiment of FIG. 9B, the first thermal adjustment device 101 is a heating device and the second thermal adjustment device 102 is a cooling device.

In alternative embodiment, the first thermal adjustment device 101 is a cooling device and the second thermal adjustment device 102 is a heating device.

In this embodiment, the partitioning wall 16 is made of liquid permeable plate or liquid permeable fabric material.

FIG. 10 shows a further embodiment of the present invention. The system 2 and growing chamber 6 of FIG. 10 corresponds the system 2 and growing chamber 6 of FIG. 8A. In this embodiment, the partitioning wall 16 is made of liquid permeable plate or liquid permeable fabric material. The growing chamber 6 is provided with a third thermal adjustment device 130 arranged to the upper growing chamber 20. The third thermal adjustment device 130 arranged to adjust temperature in the upper growing space 20.

The third thermal adjustment device 130 may be heating device, cooling device or a combined heating and cooling device, as disclosed above. The third thermal adjustment device 130 may be for example electrical heating device, electrical cooling device, combined electrical heating and cooling device, or heat exchanger arranged to adjust temperature of the growing liquid in the system, or some other liquid heating and/or cooling device. Preferably, the third thermal adjustment device 130 is a radiant thermal adjustment device such as a radiant heater and/or cooler.

The third thermal adjustment device 130 may be connected to a third power source 140 for adjusting the operation and/or temperature provided by the third thermal adjustment device. The third power source 130 may be an electric power source for operating the electric heater or cooler, or a liquid power source or heat or cold source for providing heated or cooled working fluid to the heat exchanger 130.

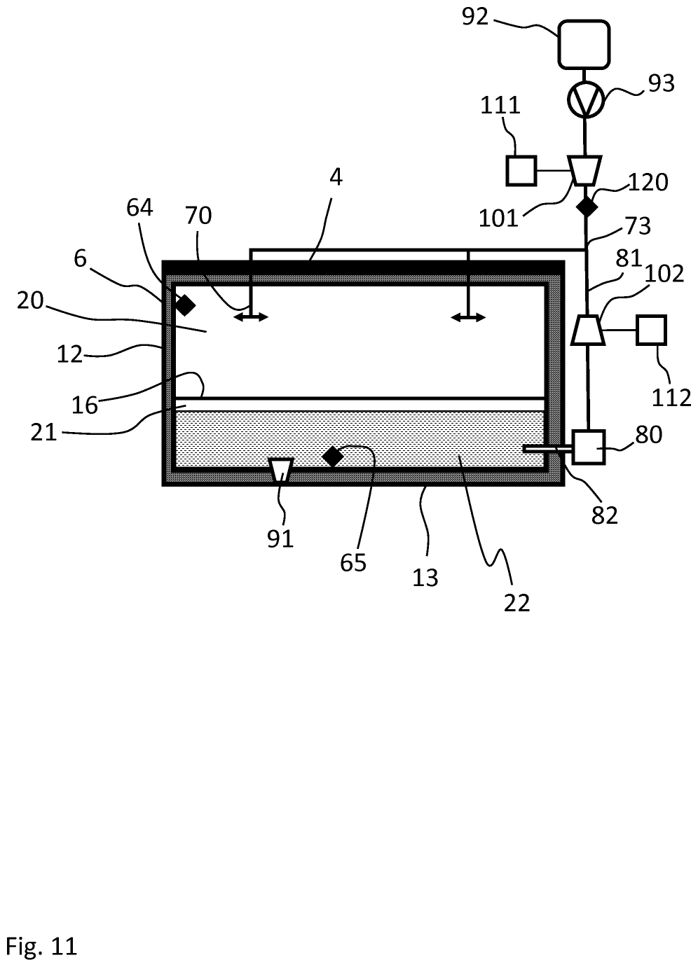

FIG. 11 shows an embodiment which is a combination of embodiment of FIGS. 6 and 8B.

In this embodiment, the system 2 further comprises the first thermal adjustment device 101 provided in connection with or to the inlet arrangement. Further, the first thermal adjustment device 101 is provided to or in connection with the growing liquid supply channel 73 connected to the one or more growing liquid nozzles 70, 71. Thus, the first thermal adjustment device 101 is arranged to adjust temperature of the growing liquid in the supply channel 73. Thus, the first thermal adjustment device 101 is arranged to adjust temperature of the growing liquid 22 sprayed from the growing liquid nozzles 70, 71 to the closed chamber space 20 or to the upper growing space 20. Further, the first thermal adjustment device 101 is arranged to adjust the temperature of the growing liquid upstream of the growing liquid nozzles 70 and/or before spraying the growing liquid with the growing liquid nozzles 70 to the closed chamber space 20.

In the embodiment of FIG. 11, the first thermal adjustment device 101 is arranged downstream of the supply pump 93 and between the supply pump 93 and the growing chamber 6 or the growing liquid nozzles 70. Alternatively, the first thermal adjustment device 101 may arranged upstream of the supply pump 93 and between the growing chamber source 92 and the supply pump 93.

In the embodiment of FIG. 11, the second thermal adjustment device 102 is provided to or in connection with the circulation arrangement 80, 81. Further, the second thermal adjustment device 102 is provided to or in connection with the circulation channel 81. Alternatively, the second thermal adjustment device 102 may be provided to or in connection with the circulation pump 80.

The embodiment of FIG. 11 may also be modified by arranging the circulation arrangement 80, 81 inside the growing chamber 6, as in FIGS. 8A, 9A and 10.

The embodiment FIG. 11 allows adjusting temperature both the circulated growing liquid and the new added growing liquid when they are sprayed to the growing chamber 6.

It should be noted that, embodiments of FIGS. 6 and 7 may also be combined with embodiments of FIGS. 8A and 8B for using two thermal adjustment devices 101, 102.

The present invention provides a method for aeroponic farming in which the temperature inside the growing chamber is adjusted by adjusting the temperature of the growing liquid used in the system 2.

The method of present invention comprises spraying growing liquid 22 in the closed chamber space 20, 21 to the root part 54 of the plant 50 with one or more growing liquid nozzles 70, 71. The method further comprises adjusting temperature inside the closed chamber space 20, 21 of the growing chamber 6 by adjusting temperature of the growing liquid 22.

In one embodiment, the method comprises adjusting the temperature of the growing liquid 22 sprayed the in closed chamber space 20, 21 for adjusting the temperature of the inside the closed chamber space 20, 21. This embodiment may be implemented for example with the systems 2 of FIGS. 6, 7, 8A, 8B, 9A, 9B, 10 and 11.

In one embodiment, the method comprises collecting excessive sprayed growing liquid 22 inside the closed chamber space 20, 21 of the growing chamber 6 to a growing liquid reservoir 12, 13, 200, and adjusting temperature of the growing liquid 22 collected to the growing liquid reservoir 12, 13, 200 in the growing liquid reservoir 12, 13, 200 for adjusting the temperature of the inside the closed chamber space 20, 21. This embodiment may be implemented for example with the systems 2 of FIGS. 8A, 9A, 9B and 10.

In a further embodiment, the method comprises collecting excessive sprayed growing liquid 22 inside the closed chamber space 20, 21 of the growing chamber 6 to the growing liquid reservoir 12, 13, 200, circulating the collected growing liquid 22 from the growing liquid reservoir 12, 13, 200 to one or more growing liquid nozzles 70, 71, and adjusting the temperature of the circulated growing liquid 22 for adjusting the temperature of the inside the closed chamber space 20, 21. This embodiment may be implemented for example with the systems 2 of FIGS. 8A, 8B, 9A, 9B, 10 and 11.

The method may further comprise measuring temperature inside the growing chamber 6 with one or more temperature sensors and adjusting the temperature of the growing liquid based on the measurement results.

The measured temperature may be compared to a predetermined temperature value and the temperature of the growing liquid is adjusted based on comparison of the measurement temperature and the predetermined temperature value.

Further, the method may comprise measuring temperature inside the growing chamber with a first temperature sensor 64 and temperature of the growing liquid with a second temperature sensor 65. The first temperature sensor 64 may be provided to the upper growing space 20 or outside the growing liquid reservoir 12, 13 200 inside the growing chamber 6. The second temperature sensor 65 is arranged to measure the temperature of the growing liquid which is sprayed to the growing chamber 6 and/or the upper growing space 20. Thus, the second temperature sensor 65 may be provided to the growing liquid reservoir 12, 13, 200, to the inlet arrangement 92, 93, 73 or to the circulation arrangement 80, 81 or in connection with the growing liquid nozzles 70, 71.

The method may further comprise measuring temperature inside the growing chamber 6 with the first temperature sensor and measuring temperature of the growing liquid the second temperature sensor and adjusting the temperature of the growing liquid based on comparison of the measurement results of the first and second temperature sensors 64, 65.

The measured temperatures of the first and second temperature sensors 64, 65 may be compared to a predetermined temperature value and the temperature of the growing liquid is adjusted based on comparison of the measurement temperatures of the first and second temperature sensors and the predetermined temperature value.

The invention has been described above with reference to the examples shown in the figures. However, the invention is in no way restricted to the above examples but may vary within the scope of the claims.

1.-16. (canceled)

17. An aeroponic farming system for growing plants having an aerial shoot and underground root part, the system comprising:
a plant support base for supporting the plant, the plant support base comprises a support opening arranged to support the plant such that the plant extends through the plant support base via the support opening and such that the aerial shoot is arranged on a first side of the plant support base and the root part is arranged on a second side the plant support base;
a growing chamber provided on the second side of the plant support base, the growing chamber comprising growing chamber walls defining a closed chamber space, the growing chamber walls being non-transparent; and
one or more growing liquid nozzles arranged to spray growing liquid inside the closed chamber space of the growing chamber,
wherein the aeroponic farming system comprises a thermal adjustment device arranged to adjust temperature of the growing liquid in the aeroponic farming system for adjusting the temperature in the inside the closed chamber space of the growing chamber,
the growing chamber comprises a growing liquid reservoir inside the growing chamber for storing growing liquid inside the closed chamber space of the growing chamber;
the growing chamber comprises a partitioning wall arranged to divide the closed chamber space into an upper growing space and a lower liquid space, the upper growing space being provided between the plant support base and the partitioning wall for enclosing the root part of the plant and the lower liquid space being provided between the partitioning wall and a bottom wall of the growing chamber, the lower liquid space comprising the growing liquid reservoir inside the growing chamber for storing growing liquid inside the closed chamber space of the growing chamber; and
the partitioning wall is arranged to allow excessive growing liquid flow through the partitioning wall from the upper growing space to the lower liquid space.

18. The aeroponic farming system according to claim 17, wherein the thermal adjustment device is arranged to adjust temperature of the growing liquid sprayed from the growing liquid nozzles.

19. The aeroponic farming system according to claim 18, wherein:
the system comprises a growing liquid supply channel connected to the one or more growing liquid nozzles, and the thermal adjustment device is provided in connection with the growing liquid supply channel and arranged to adjust temperature of the growing liquid sprayed from the growing liquid nozzles; or
the system comprises a growing liquid supply pump arranged to supply growing liquid to the one or more growing liquid nozzles, and the thermal adjustment device is provided in connection with the growing liquid supply pump and arranged to adjust temperature of the growing liquid sprayed from the growing liquid nozzles; or
the system comprises a growing liquid source connected to the one or more growing liquid nozzles, and the thermal adjustment device is provided in connection with the growing liquid source and arranged to adjust temperature of the growing liquid sprayed from the growing liquid nozzles.

20. The aeroponic farming system according to claim 17, wherein:
the partitioning wall is made of liquid permeable fabric material, net material, or grid material allowing excessive growing liquid flow through the partitioning wall from the upper growing space to the lower liquid space; or
the partitioning wall is made of liquid impermeable plate material or liquid impermeable fabric material and provided with flow openings allowing excessive growing liquid flow through the partitioning wall from the upper growing space to the lower liquid space; or
the partitioning wall is made of liquid impermeable plate or liquid impermeable fabric material, and the system comprises a flow connection provided or extending between the upper growing space and the lower liquid space allowing excessive growing liquid flow from the upper growing space to the lower liquid space.

21. The aeroponic farming system according to claim 17, wherein:
the thermal adjustment device is arranged to adjust the temperature of the growing liquid in the growing liquid reservoir;
the thermal adjustment device is arranged in connection with the growing liquid reservoir and arranged to adjust the temperature of the growing liquid in the growing liquid reservoir.

22. The aeroponic farming system according to claim 17, wherein the system comprises a growing liquid circulation arrangement arranged to supply growing liquid from the growing liquid reservoir to one or more of the growing liquid nozzles.

23. The aeroponic farming system according to claim 22, wherein:
the growing liquid circulation arrangement comprises a circulation channel connected to the one or more growing liquid nozzles, and the thermal adjustment device is provided in connection with the circulation channel and arranged to adjust temperature of the growing liquid sprayed from the growing liquid nozzles; or
the growing liquid circulation arrangement comprises circulation pump arranged to supply growing liquid to the one or more growing liquid nozzles from the growing liquid reservoir, and the thermal adjustment device is provided in connection with the circulation pump and arranged to adjust temperature of the growing liquid sprayed from the growing liquid nozzles.

24. The aeroponic farming system according to claim 17, wherein the thermal adjustment device is a heating device or a cooling device or a combined heating and cooling device.

25. The aeroponic farming system according to claim 17, wherein the system comprises a first thermal adjustment device and a second thermal adjustment device, and that:
the first thermal adjustment device is arranged in connection with the growing liquid supply channel, supply pump or the growing liquid source, and the second thermal adjustment device is arranged in connection with the growing liquid reservoir; or
the first thermal adjustment device is arranged in connection with the growing liquid supply channel, supply pump or the growing liquid source, and the second thermal adjustment device is arranged in connection with the circulation arrangement; or
the first thermal adjustment device is arranged in connection with the growing liquid reservoir and the second thermal adjustment device is arranged in connection with the circulation arrangement.

26. The aeroponic farming system according to claim 25, wherein:
the first thermal adjustment device is a heating device and the second thermal adjustment device is a cooling device; or
the first thermal adjustment device is a cooling device and the second thermal adjustment device is a heating device; or
the first thermal adjustment device is a heating device and the second thermal adjustment device is a heating device; or
the first thermal adjustment device is a cooling device and the second thermal adjustment device is a cooling device.

27. The aeroponic farming system according to claim 17, wherein the growing chamber is provided with a thermal insulation arranged to thermally insulate the closed chamber space.

28. A method for aeroponic farming of tuber plants or root vegetable plants having an aerial shoot and an underground root part, the aeroponic farming being carried with:
an aeroponic farming system comprising a growing chamber having growing chamber walls defining a closed chamber space for accommodating the root part of the plant;
the growing chamber walls being non-transparent;
the growing chamber comprises a growing liquid reservoir inside the growing chamber for storing growing liquid inside the closed chamber space of the growing chamber; and
the growing chamber comprises a partitioning wall arranged to divide the closed chamber space into an upper growing space and a lower liquid space, the upper growing space being provided between the plant support base and the partitioning wall for enclosing the root part of the plant and the lower liquid space being provided between the partitioning wall and a bottom wall of the growing chamber, the lower liquid space comprising the growing liquid reservoir inside the growing chamber for storing growing liquid inside the closed chamber space of the growing chamber; and
the method comprising:
spraying growing liquid in the closed chamber space to the root part of the plant with one or more growing liquid nozzles, wherein the method further comprises:
adjusting temperature inside the closed chamber space of the growing chamber by adjusting temperature of the growing liquid; and
allowing excessive growing liquid flow through the partitioning wall from the upper growing space to the lower liquid space.

29. The method according to claim 28, wherein the method comprises adjusting the temperature of the growing liquid sprayed the in closed chamber space for adjusting the temperature of the inside the closed chamber space.

30. A method according to claim 28, wherein the method comprises:
collecting excessive sprayed growing liquid inside the closed chamber space of the growing chamber to a growing liquid reservoir; and
adjusting temperature of the growing liquid collected to the growing liquid reservoir in the growing liquid reservoir for adjusting the temperature of the inside the closed chamber space.

31. The method according to claim 28, wherein the method comprises:
collecting excessive sprayed growing liquid inside the closed chamber space of the growing chamber to the growing liquid reservoir;
circulating the collected growing liquid from the growing liquid reservoir to one or more growing liquid nozzles; and
adjusting the temperature of the circulated growing liquid for adjusting the temperature of the inside the closed chamber space.

32. The method according to claim 28, wherein the method is carried out with an aeroponic farming system for growing plants having an aerial shoot and underground root part, the system comprising:
a plant support base for supporting the plant, the plant support base comprises a support opening arranged to support the plant such that the plant extends through the plant support base via the support opening and such that the aerial shoot is arranged on a first side of the plant support base and the root part is arranged on a second side the plant support base;
a growing chamber provided on the second side of the plant support base, the growing chamber comprising growing chamber walls defining a closed chamber space, the growing chamber walls being non-transparent; and
one or more growing liquid nozzles arranged to spray growing liquid inside the closed chamber space of the growing chamber,
wherein the aeroponic farming system comprises a thermal adjustment device arranged to adjust temperature of the growing liquid in the aeroponic farming system for adjusting the temperature in the inside the closed chamber space of the growing chamber,
the growing chamber comprises a growing liquid reservoir inside the growing chamber for storing growing liquid inside the closed chamber space of the growing chamber;
the growing chamber comprises a partitioning wall arranged to divide the closed chamber space into an upper growing space and a lower liquid space, the upper growing space being provided between the plant support base and the partitioning wall for enclosing the root part of the plant and the lower liquid space being provided between the partitioning wall and a bottom wall of the growing chamber, the lower liquid space comprising the growing liquid reservoir inside the growing chamber for storing growing liquid inside the closed chamber space of the growing chamber; and
the partitioning wall is arranged to allow excessive growing liquid flow through the partitioning wall from the upper growing space to the lower liquid space.
